(19) United States
(12) Patent Application Publication
(10) Pub. No.: US 2017/0113331 A1
(43) Pub. Date: Apr. 27, 2017

(54) 4-IN-1 MULTIPLE SOCKET DRIVER

(71) Applicant: Malco Products, Inc., Annandale, MN (US)

(72) Inventors: Bryan LAI, Taichung (TW); Thomas A. BATHO, South Haven, MN (US)

(21) Appl. No.: 15/049,873

(22) Filed: Feb. 22, 2016

Related U.S. Application Data
(63) Continuation-in-part of application No. 62/246,371, filed on Oct. 26, 2015.

(51) Int. Cl. B25B 13/10

(52) U.S. Cl. CPC B25B 13/102

(57) ABSTRACT

A 4-in-1 multiple socket driver has an outer hexagonal sleeve with two ends each having one of a first intermediate large and second largest hexagonal sockets. A hand grippable handle is formed over an intermediate section of the outer sleeve. An inner hexagonal shaft with two ends each having one of a third smallest and fourth intermediate small hexagonal sockets. The inner shaft is adapted to slidably fit within the outer hex sleeve while being rotationally locked to the outer hexagonal sleeve. An axial locking mechanism is provided between the outer hexagonal sleeve and the inner hexagonal shaft to selectively present two of the four hexagonal sockets at any one time for operational use and to effectively lock the inner hexagonal shaft within the out hexagonal sleeve.

### PRIORITY CLAIM

This application is a Continuation-in-part of U.S. Provisional Patent Application Ser. No. 62/246,371 filed on Oct. 26, 2015 for a 4-in-1 Multiple Socket Driver.

### BACKGROUND OF THE INVENTION

This invention relates to hex drivers, and more particularly to, 4-in-1 multiple socket hexagonal driver.

Hexagonal headed screws and nuts are quite common for fastening two pieces together in sheet metal applications and in machined parts. Socket sets with ratchet drivers, dedicated single hex drivers and box wrenches were quite common to drive and secure hex head screws, hex head machine bolts and hex-shaped nuts. Dedicated hand-held single hex drivers are common where limited sized hex heads have been used in particular industries. For instance, in sheet metal applications, hex heads with outer dimensions of ¼, 5/16. ⅜ and 7/16 inches are quite common.

Many workers carry tool boxes or wear tool belts that carrying tools and drivers that are specific to the workers' occupation. Such belts might carry variously-sized socket drivers, cutters, a ruler, snips, wire strippers, wrenches, etc.

There is a need for a 4-in-1 multiple socket driver that takes the place of four hand-held socket drivers that will free up space in a tool box or tool belt. Such a driver should be easy to manipulate to select one of four sizes of sockets common in the workers' occupation.

### SUMMARY OF THE INVENTION

A 4-in-1 multiple socket driver has an outer hexagonal sleeve with two ends each having one of a first intermediate large and second largest hexagonal sockets. A hand grippable handle is formed over an intermediate section of the outer sleeve. An inner hexagonal shaft with two ends each having one of a third smallest and fourth intermediate small hexagonal sockets. The inner shaft is adapted to slidably fit within the outer hex sleeve while being rotationally locked to the outer hexagonal sleeve. An axial locking mechanism is provided between the outer hexagonal sleeve and the inner hexagonal shaft to selectively present two of the four hexagonal sockets at any one time for operational use and to effectively lock the inner hexagonal shaft within the out hexagonal sleeve.

A principle object and advantage of the present invention is that it provides four socket drivers in one tool rendering the invention an unique space saving socket driver that takes the place of four socket drivers for use by a worker that takes little space in a tool box or tool belt as heretofor not known.

Another object and advantage of the present invention is that the locking mechanism is simple and can be operated by one hand as the worker selects the desired socket for the driver to present for driving a particular hexagonal screw, nut or bolt.

Another object and advantage of the present invention is that the present invention provides four choices of sockets in one socket driver tool while yet being shorter than a single socket driver.

Another object and advantage of the present invention is that the axially slidable inner hex shaft cannot be withdrawn from the tool and be possibly lost.

### BRIEF DESCRIPTION OF THE DRAWINGS

FIG. 1 is an exploded view of the 4-in-1 multiple socket driver showing all parts;

FIG. 2 is an enlarged cross sectional view partially broken away showing the detail of the locking mechanism securely locking the outer hex sleeve and the inner hex shaft together;

FIG. 3 is an enlarged vertical cross sectional view partially broken away showing the detail of the locking mechanism unlocked so that the inner hex shaft can be moved relative to the outer hex sleeve as to present different hex sockets to the worker;

FIG. 4 is a vertical cross sectional view showing the detail of the locking mechanism securely locking the outer hex sleeve and the inner hex shaft together in a first locked position presenting the first intermediate large socket of the outer hex sleeve and fourth intermediate small socket of the inner sleeve;

FIG. 5 is a vertical cross sectional view showing the detail of the locking mechanism securely locking the outer hex sleeve and the inner hex shaft together in a second locked position presenting the third smallest socket and fourth intermediate small socket of the inner hex shaft; and

FIG. 6 is a vertical cross sectional view showing the detail of the locking mechanism securely locking the outer hex sleeve and the inner hex shaft together in a third locked position presenting the third smallest socket of the inner hex shaft and the second largest socket of the outer hex sleeve.

### DETAILED SPECIFICATION

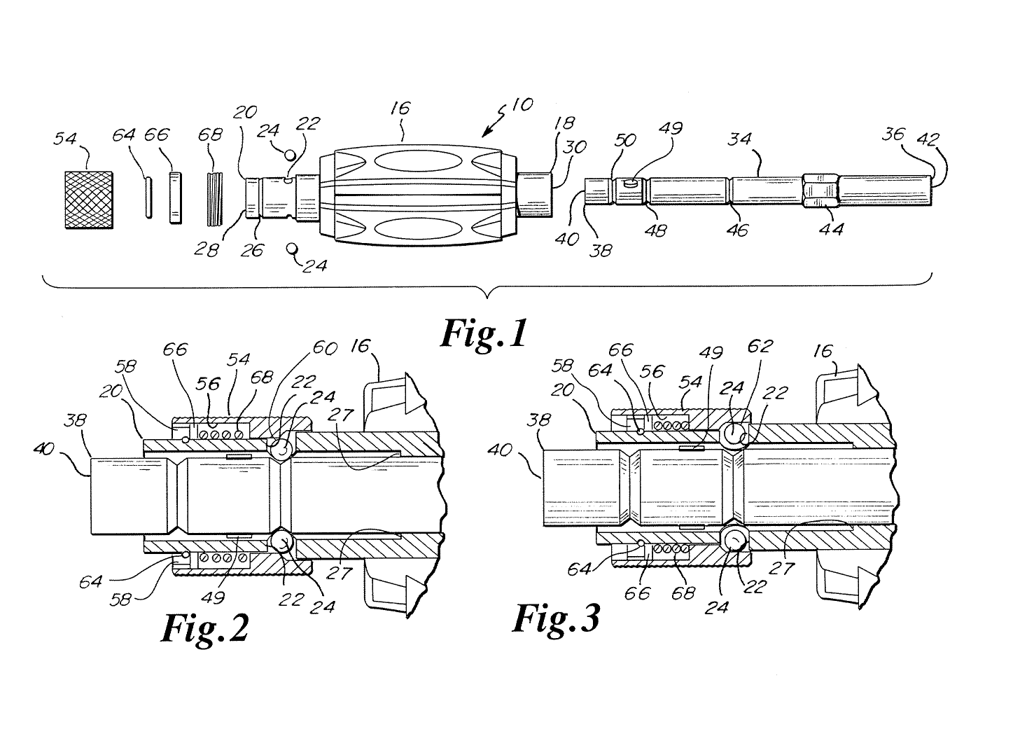

Referring to FIG. 1, the parts and features of the 4-in-1 multiple socket driver 10 of the present invention maybe viewed and appreciated. The outer hex sleeve 14 suitably has an over-molded hand grippable handle 16 secured thereto. The sleeve 14 has a first end 18 and a second end 20. At the second end 20 is located a position lock 22 on the sleeve comprising the combination of opposing holes 22 and locking balls 24. A retaining ring lock or annular channel 26 is also on the second end 20 of sleeve 14. Sleeve 14 also has an inner lock collar 27 which will be appreciated later with introduction of other parts. Sleeve 14 has a first intermediate large hex socket 28 on the second end 20 and a second largest hex socket 30 on its first end 18.

Inner hex shaft 34 has a first end 36 and a second end 38. At the first end 36 is located fourth intermediate small hex socket 42. At the second end 38 is located third smallest hex socket 40. The inner hex shaft has at least a partial hex collar 44 rendering the inner hex shaft slidable within, but non-rotatable, in relation to the outer hex sleeve 14 due to the outer hex sleeve having its second largest hex socket 42 extending inwardly from the from the socket 42. Also, the partial hexagonal collar 44 will not pass the outer sleeve 14 inner lock collar 27. There are three position locks on the inner hex shaft 34 including a middle position lock or annular channel 46, an intermediate position lock or annular channel 48 and end position lock or annular channel 50.

Stop pin 49 is between interim annular channel 48 and end annular channel 50 which will not pass inner collar 27 inside outer hexagonal sleeve 14. By this arrangement, the inner shaft 34 hexagonal collar 44 and stop pin 49 effectively locks inner shaft 34 within outer hexagonal sleeve 14 to prevent loss of the inner hexagonal shaft 34.

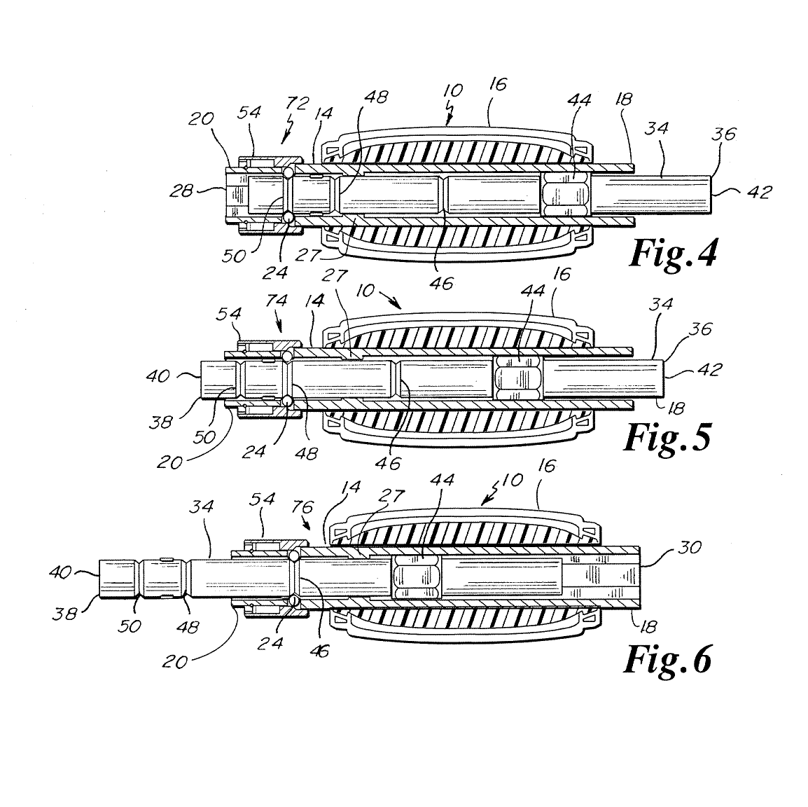

The locking sleeve 54 shown in FIGS. 1 through 3 selectively secures the inner hex shaft 34 within the outer hex sleeve 14—particular in first lock position 72, second lock position 74 or third lock position 76 (FIGS. 4 through 6, respectively). The cylindrical locking sleeve 54 has a spring cavity 56 on its underside along with a retaining ring cavity 58, ball lock surface 60 and ball release surface 62. A retainer ring 64 is fitted into retainer ring lock or annular groove or channel 26 on the outer hex sleeve 14 and is also captured by retainer ring cavity 58 securing the sleeve 54 to the outer shaft hex shaft 14 while permitting axial movement of the locking sleeve 54 on the outer hex sleeve 14.

Referring to FIGS. 4 through 6, the operation of the 4-in-1 multiple socket driver 10 may be appreciated. The locking sleeve 54 is in static first lock position 72 with its ball lock surface 60 holding balls 24 in opposing position lock holes 22 and engaged in the annular channel 50. By this arrangement, first intermediately large socket 28 (⅜ inch) on the outer hex sleeve 14 and fourth intermediate small socket 42 ( 5/16 inch) on the inner hex shaft 34 are presented for use. For another socket selection, the worker moves the sleeve 54 against the tension of the spring 68 as to release balls 24 from their locked condition in end position lock or annular channel 50 and slides the inner hex shaft 34 to either the intermediate position lock or annular channel 48 (or middle position lock or annular channel 46) and releases the locking sleeve 54 as to force balls 24 into locking engagement within middle position lock or annular channel 48 thereby presenting third smallest hex socket 40 (¼ inch) on inner hex shaft 34 and fourth intermediate small socket 42 ( 5/16 inch) on inner hex shaft 34. Alternatively, the worker could have selected the intermediate position lock or annular channel 48 thereby presenting third smallest hex socket 40 (¼ inch) on inner hex shaft 34 and second largest hex socket 30 ( 7/16 inch) on outer hex sleeve 14.

Advantageously, the worker can pull back locking sleeve 54 and move the inner hex shaft 34 to any of first, second or third lock positions 72, 74 or 76 without fear of losing the inner hexagonal shaft 34 due to it falling out of the tool 10.

The above specification, sizes and accompanying Figures are for illustrative purposes only. The true scope of the present invention is defined by the following claims.

What is claimed:

1. A 4-in-1 multiple socket driver, comprising:
a) an outer hexagonal sleeve with two ends each having one of a first intermediate large and second largest hexagonal sockets;
b) a hand grippable handle formed over an intermediate section of the outer sleeve;
c) an inner hexagonal shaft with two ends each having one of a third smallest and a fourth intermediate small hexagonal sockets, the inner shaft adapted to slidably fit within the outer hex sleeve; and
d) an axial locking mechanism between the outer hexagonal sleeve and the inner hexagonal shaft to slidably interlock the inner hex shaft to the outer hexagonal sleeve to selectively present two of the four hexagonal sockets at any one time for operational use.

2. The 4-in-1 multiple socket driver of claim 1, wherein the locking mechanism comprises a biased axially moving locking sleeve on one of the ends of the outer hexagonal sleeve.

3. The 4-in-1 multiple socket driver of claim 2, wherein the locking mechanism further comprises at least one hole in the outer hexagonal sleeve with at least one moveable ball within the hole, three position locks formed by three annular channels on the inner hexagonal shaft capable of interlocking with the ball.

4. The 4-in-1 multiple socket driver of claim 3, wherein the locking mechanism further comprises a ball lock surface and a ball release surface on the inside of the biased locking sleeve to respectively hold the ball in the hole and in one of the channels and to release the ball from the hole the channel.

5. The 4-in-1 multiple socket driver of claim 1 wherein the inner hexagonal shaft has a hexagonal collar to rotationally lock with one of the sockets of the outer hexagonal sleeve.

6. The 4-in-1 multiple socket driver of claim 5 wherein the outer hexagonal sleeve has an inner lock collar, the inner hexagonal shaft has a stop pin, the outer hexagonal sleeve inner lock collar will not allow the inner hexagonal shaft collar and the stop pin to pass by the inner lock collar of the outer hexagonal sleeve effectively locking the inner hexagonal shaft within the outer hexagonal sleeve.

7. The 4-in-1 multiple socket driver of claim 1, further comprising a retaining ring on the outer hexagonal sleeve to capture the locking sleeve and a coil spring over the outer hexagonal sleeve and under the locking sleeve to bias the locking sleeve.

8. A 4-in-1 multiple socket driver, comprising:
a) an outer hexagonal sleeve with two ends each having one of a first intermediate large and a second largest hexagonal sockets;
b) a hand grippable handle formed over an intermediate section of the outer sleeve;
c) an inner hexagonal shaft with two ends each having one of a third smallest and fourth intermediate small hexagonal sockets, the inner shaft adapted to slidably fit within the outer hex sleeve; and
d) an axial locking mechanism between the outer hexagonal sleeve and the inner hexagonal shaft to slidably interlock the inner hex shaft to the outer hexagonal sleeve to selectively present two of the four hexagonal sockets at any one time for operational use wherein the locking mechanism comprises a biased locking sleeve on one of the ends of the outer hexagonal sleeve and at least one hole in the outer hexagonal sleeve with at least one moveable ball within the hole, three position locks formed by three annular channels on the inner hexagonal shaft capable of interlocking with the ball.

9. The 4-in-1 multiple socket driver of claim 8, wherein the locking mechanism further comprises a ball lock surface and a ball release surface on the inside of the biased locking sleeve to respectively hold the ball in the hole and in one of the channels and to release the ball from the hole and the channels.

10. The 4-in-1 multiple socket driver of claim 8 wherein the inner hexagonal shaft has a hexagonal collar to rotationally lock with the large hexagonal socket of the outer hexagonal sleeve.

11. The 4-in-1 multiple socket driver of claim 10 wherein the outer hexagonal sleeve has an inner lock collar, the inner hexagonal shaft has a stop pin, the outer hexagonal sleeve inner lock collar will not allow the inner hexagonal shaft collar and the stop pin to pass by the inner lock collar of the outer hexagonal sleeve effectively locking the inner hexagonal shaft within the outer hexagonal sleeve.

12. The 4-in-1 multiple socket driver of claim 8, further comprising a retaining ring on the outer hexagonal sleeve to capture the locking sleeve and a coil spring over the outer hexagonal sleeve and under the locking sleeve to bias the locking sleeve.

13. A 4-in-1 multiple socket driver, comprising:
a) an outer hexagonal sleeve with two ends each having one of a first intermediate large and a second largest hexagonal sockets;
b) a hand grippable handle formed over an intermediate section of the outer sleeve;
c) an inner hexagonal shaft with two ends each having one of a third smallest and fourth intermediate small hexagonal sockets, the inner shaft adapted to slidably fit within the outer hex sleeve and having a hexagonal collar to rotationally lock with the large hexagonal socket of the outer hexagonal sleeve;
d) an axial locking mechanism between the outer hexagonal sleeve and the inner hexagonal shaft to slidably interlock the inner hex shaft to the outer hexagonal sleeve to selectively present two of the four hexagonal sockets at any one time for operational use wherein the locking mechanism comprises a biased locking sleeve on one of the ends of the outer hexagonal sleeve and at least one hole in the outer hexagonal sleeve with at least one moveable ball within the hole, three position locks formed by three annular channels on the inner hexagonal shaft capable of interlocking with the ball and a ball lock surface and a ball release surface on the inside of the biased locking sleeve to respectively hold the ball in the hole and one of the channels and to release the ball from the hole and the channel.

14. The 4-in-1 multiple socket driver of claim 13, further comprising a retaining ring on the outer hexagonal sleeve to capture the locking sleeve and a coil spring over the outer hexagonal sleeve and under the locking sleeve to bias the locking sleeve in a locked position.

15. The 4-in-1 multiple socket driver of claim 13 wherein the outer hexagonal sleeve has an inner lock collar, the inner hexagonal shaft has a stop pin, the outer hexagonal sleeve inner lock collar will not allow the inner hexagonal shaft collar and the stop pin to pass by the inner lock collar of the outer hexagonal sleeve effectively locking the inner hexagonal shaft with the outer hexagonal sleeve.
